(19) United States
(12) Patent Application Publication
(10) Pub. No.: US 2002/0166592 A1
(43) Pub. Date: Nov. 14, 2002

(54) Apparatus and method for small-volume fluid manipulation and transportation

(76) Inventors: Shaorong Liu, Tracy, CA (US); Juan Lu, Tracy, CA (US)

Correspondence Address: LIU & LIU LLP, Suite 1100, 811 West 7th Street, Los Angeles, CA, 90017, US

(21) Appl. No.: 10/076,170

(22) Filed: Feb. 11, 2002

Related U.S. Application Data
(60) Provisional application No. 60/267,474, filed on Feb. 9, 2001.
(60) Provisional application No. 60/278,508, filed on Mar. 23, 2001.

(51) Int. Cl. F15C 1/04; G01N 27/26; G01N 27/447

(52) U.S. Cl. 137/825; 204/451; 204/453; 204/601; 204/602; 204/604; 422/100; 436/180; 417/48; 417/50; 137/13

(57) ABSTRACT

A microfluidic system has an electroosmotic flow (EOF) pumping means for propelling fluids through a series of microchannels and selection valves. Pump channels are configured in groups which may be fabricated singly or in multiple groups onto a substrate. A bubble-free electric connection joint provides for the application of voltages across pump channels while simultaneously blocking the passage of fluids through the joint. Bubble-free electrodes are also provided to prevent electrolysis and bubble formation in or close to the microfluidic channels. The selection valves provide for routing functions within the microfluidic system and can also be configured to route fluids outside the system. A rate monitoring system is provided for determining and compensating for system flow rates. In one application the microfluidic system may be configured to operate as a small volume pipettor or other fluid transport or analysis device. A pipettor washing device is provided to facilitate complete and accurate delivery of the target fluid, and a method for completely transferring small fluid volumes to dry surfaces is also provided. A micro-dialysis jacket is additionally provided for the pipettor system to permit desalting, pH adjustment, concentration adjustment, and other functions.

This patent application claims the benefit under 35 U.S.C. § 119(e) of U.S. provisional patent applications Serial No. 60/267,474, filed on Feb. 09, 2001, and Serial No. 60/278,508, filed on Mar. 23, 2001.

### BACKGROUND OF THE INVENTION

1. Field of the Invention

The present invention generally concerns miniature instrumentation for the facilitation of chemical reactions and the analytical separation of chemical solutions. More specifically, this invention concerns the manipulation of fluids in microfluidic chips and transportation of fluids between external devices and microfluidic chips for the facilitation of chemical reactions and the analytical separation of chemical solutions. In particular this invention provides a reliable and functionally versatile microfabricated electroosmotic flow pump with integrated microfluidic conduits on a single chip.

2. Description of Related Art

The field of microfluidics utilizes fabrication techniques borrowed from the semiconductor industry to cost effectively miniaturize and mass-produce extremely complex fluid systems. These microfluidic systems take advantage of the physical properties and flow characteristics of fluids within channels or capillaries to perform transportive and analytical functions on aqueous chemical solutions. Common applications of microfluidics include micro-pipetting, microarray spotting, sample deposition for MALDI-MS, as well as integrated microfluidic systems for chemical analysis and sensing, and analytical separation techniques such as capillary electrophoresis, capillary electrochromatography, microcolumn liquid chromatography, and flow injection analysis.

One of the main principles incorporated in microfluidic chips to facilitate the transportation or pumping of fluids is called electroosmotic flow or (EOF). EOF principles have been known for nearly two centuries, but only in the most recent decades has it been practiced on a microscopic level. To explain EOF in brief, the surface of many solids carries a net charge when in contact with an aqueous solution due to chemical associations or dissociations, physical adsorption on, or desorption from the solid surface. For example, at mildly acidic to alkaline pH, surfaces of quartz, ceramics, clay, sand, etc. are negatively charged. The charged surface attracts oppositely charged counterions present in the aqueous solution. As a result, a higher concentration of the counterions builds near the surface and thermodynamic processes forces these counterions to diffuse back into the bulk solution. At equilibrium, the two processes balance each other, and the counterions form a diffuse double layer. This diffuse double layer is often called the Guoy-Chapman layer. Application of an external electric field results in a net migration of these counterions in the diffuse double layer towards the oppositely charged electrodes. Due to viscous drag, the whole solution contained in microporous or capillary structures moves with the counterions. This flow is called electroosmotic flow.

EOF as well as other fluid propulsion methods have been utilized in prior art microfluidic systems, but all lack the level of sophistication, functionality, and ease of production inherent in the current invention. For example, the inventor considered the EOF fluid propulsion means described in U.S. Pat. No. 5,573,651 for flow injection analysis (FIA). Capillary tubes are used to generate EOF by connecting the pump capillary tubes and FIA conduits through an ion exchangeable membrane tube that maintains hydraulic connectivity between the pump capillary tubes and FIA conduits while also serving as an electric grounding point for the system. The grounding point provides for the elimination of electric fields in the FIA reaction zone. To increase the fluid flow rate, multiple capillaries are used, but in practice, connecting the FIA conduits and pump capillaries via the ion exchangeable membrane tube becomes tedious and commercially impracticable.

Additionally, when many capillary tubes are desired to generate sufficient flow rate and pressure, it is very difficult to arrange all the capillary tubes tightly to occupy a very small space. In order to increase EOF pressure, the bore size of the pump capillary tube may be reduced, which will then decrease the flow rate. To compensate for this flow rate reduction, the number of pump capillary tubes must then be increased.

Furthermore, when fluids in the FIA system need to be merged and/or split with zero-dead volume, it is impossible to form zero-dead volume connectors using conventional capillary tubes. Fluid merging/splitting is a common event in FIA systems. For example, as described in Analytical Chemistry, 1994, 66, 1792-1798, a small dead volume T-joint was made from a segment of an experimental double bore Polytetrafluoroethylene (PTFE) tubing product that has two separate parallel channels. An oblique hole was manually punctured between the two parallel channels using a needle to make a connection between the two conduits. Three of the four ends of the two parallel channels of PTFE tubing were connected to three capillary tubes while the remaining end was blocked. A dead volume of greater than one microliter was still found to be present in the joint.

Finally, it is very difficult to construct a compact system with multiple pumps using the configuration disclosed in U.S. Pat. No. 5,573,651, especially when configuring parallel FIA systems. Parallel units are commonly integrated into one system to enhance the sample throughput. In Analytical Chemistry, 1994, 66, 1792-1798, two EOF pumps were used in a two-line FIA system to facilitate reliable measurements of chloride, but the pump electrolyte solution containers and pump capillaries made the system bulky compared to the volumes of solutions handled.

Another EOF based pumping mechanism described in Analytical Chemistry, 1997, 69, 1174-1178 for microchip ESI-MS detection was considered by the inventor. In this chip, a T-shaped channel is disclosed with three ends, only two of which are connected to electrodes. When a voltage is applied, EOF goes from one electrode to the other and the net flow in the third channel is zero. In order to create a net flow in the third channel, the channel connected to the cathode was coated with linear polyacrylamide. This coating substantially suppressed the EOF in this channel. When a voltage is applied, EOF generated in the anode channel goes directly to the third channel and ESI-MS detection may be performed. This pump however would be insufficient to propel fluids on chips because any backpressure from the system will make the fluid flow to the cathode channel.

In addition to the aforementioned difficulties, previous microchip EOF pump implementations have proven unsatisfactory because of variations introduced by electric fields, which are generally applied across the entire system to balance fluids moving in the conduit network. It is extremely challenging, if not impossible, to balance the fluid flow reliably when the ionic strength of a sample changes, adsorption of substances occurs on the channel surfaces, the solution pH varies, or the system temperature shifts.

Other pumping mechanisms were considered by the inventor for microfabricated devices. In Micro Total Analysis Systems 2001, 401-402, a squeezing micropump is described for elastomer microchips. In squeezing micropumps, a deformable channel is formed inside the elastomeric substrate. A roller, actuated by a motorized x-translator, is then rolled along the channel to squeeze the fluid inside the channel forward. The same principle is used in a peristaltic pump, which takes advantage of the flexibility of pump tubing. This roller based method is not practical for microfabricated systems, especially when complicated fluid movements are required.

Another type of squeezing pump is described in Science 2000, 288, 113-116 wherein a pump channel is sandwiched by two pieces of elastomer sheets. On top of this assembly, a third sheet with multiple parallel channels is attached with the parallel channels aligned perpendicular to the pump channel underneath. Pressurized air is then introduced into one of the parallel channels. The air pressure is sufficiently high so that it squeezes and blocks the fluid inside the pump channel. The air pressure is then introduced into the next parallel channel while maintaining the pressure level in the first channel. Because the pressure in the first parallel channel blocks the pump channel such that fluid cannot flow backwards, the fluid inside the pump channel is squeezed forward. Pressure is similarly introduced into subsequent channels to squeeze the fluid further forward. Depending on the application, pressure in the first channel may be released to allow more fluid to enter the channel. Using this method however, it is very difficult to control the fluid flow in complex devices.

It is therefore desirable to design a small, robust, and easily producible fluid pump which overcomes the deficiencies in the prior art and can be adapted to fully exploit the benefits of microfabricated devices.

### SUMMARY OF THE INVENTION

The present invention overcomes shortcomings of prior art microfluidic pumping systems and enables new applications in the field of microfluidics. In one aspect of the present invention, a microfabricated EOF pump on a microchip is disclosed which utilizes a microfabricated channel or channels to generate EOF as its pumping means. The present invention also utilizes a bubble-free electric connection joint on the chip to separate the microfabricated pump channel(s) from the chemical assay conduit(s) while maintaining hydraulic connectivity between these two parts. The present invention also permits many pump channels to be constructed for a single pump to generate sufficient flow rate with sufficient pumping power and multiple pumps to be constructed on a single chip to facilitate high throughput assays and complicated fluid manipulations and transportations. It also permits zero dead-volume connections between microfluidic channels.

One object of the present invention is to provide a method and apparatus in which microfabricated channels are utilized to construct an EOF pump on a microfabricated device;

Another object of the present invention is to provide a method and apparatus that utilizes a bubble-free electric connection joint to separate the pump channels from the rest of the microfluidic conduits such that the connection joint is electrically grounded and allows the microfabricated pump to manipulate fluids in microfluidic devices but prevents the electric field on the pump from interfering with the rest of the microfluidic conduits on the chip. It also permits application of an electric potential to the microfluidic conduits when needed;

Another object of the present invention is to provide a method and apparatus that utilizes an isolation channel to separate the pump channels from the rest of the microfluidic network such that the isolation channel maintains hydraulic connectivity between the pump channels and the rest of the microfluidic network but prevents the fluids in the microfluidic network from contaminating the pump channels and pump solution;

Another object of the present invention is to provide a bubble-free electrode that permits application of an external voltage/current source to a microfluidic channel but prevent bubbles from forming in the microfluidic channel;

Yet another object of the present invention is to provide a method and apparatus that utilizes a selection valve to direct fluids to different channels in a microfluidic device;

Yet another object of the present invention is to provide a method and apparatus that utilizes an air bubble or oil droplet as a marker to monitor the flow rate in a microfluidic device;

Still another object of the present invention is to provide a method and apparatus that utilizes a microfabricated EOF pump to construct a pipetting device to transport small volumes of fluids between external sample and/or reagent holders and microfluidic devices;

Another object of the present invention is to provide a method and apparatus that utilizes a membrane jacket on the pipettor to perform sample treatment such as desalting, pH adjustment, concentration and dilution;

Another object of the present invention is to provide a method and apparatus that integrates a membrane jacket to a microfluidic device to perform sample treatment such as desalting, pH adjustment, concentration and dilution.

### BRIEF DESCRIPTION OF THE DRAWINGS

FIG. 1 is a schematic representation of a microfluidic chip containing a microfabricated EOF pump and microfluidic conduits that are connected to the selection valve, in accordance with one embodiment of the present invention;

FIG. 2a is a side-view schematic representation of an alternative bubble-free electric connection joint; FIG. 2b is a side view representation of another alternative bubble-free electric connection joint; FIG. 2c is a top-view schematic representation of the alternative bubble-free electric connection joint of FIG. 2b;

FIG. 3a is a schematic representation of an alternative configuration of a microfabricated EOF pump containing a bubble-free electrode; FIG. 3b is a side view schematic of the bubble-free electrode of FIG. 3a;

FIG. 4 is an exploded view schematic representation of a microfluidic selection valve;

FIG. 5a is a schematic representation of a multiple-tip small volume pipettor based on EOF pumping; FIG. 5b is a magnified view of a single small volume pipettor of FIG. 5a;

FIG. 6a is a schematic representation of a cleaning device for the EOF pumped pipettor; FIG. 6b is a scheme to release a small volume of fluid to a targeted location;

FIG. 7a is a magnified portion of the flow rate monitoring assembly for the microfluidic device including an air bubble and two photodiode pairs; FIG. 7b is a schematic representation of the construction of one on-chip photodiode/LED pair of FIG. 7a; FIG. 7c is a schematic representation of a flow rate monitoring assembly for the microfluidic device; and

FIG. 8a is a schematic representation of the construction of a membrane jacket on a small volume pipettor; FIG. 8b is a sectional view of a chip with two access holes for integration of a membrane into a microfluidic chip; FIG. 8c is a sectional view of the chip in FIG. 8b after a groove is made between the two access holes; FIG. 8d is a top-view of FIG. 8c; FIG. 8e is a sectional view of the completed membrane-integrated microfluidic chip.

### DETAILED DESCRIPTION OF THE INVENTION

This invention is described below in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense. The scope of the invention is best determined by reference to the appended claims.

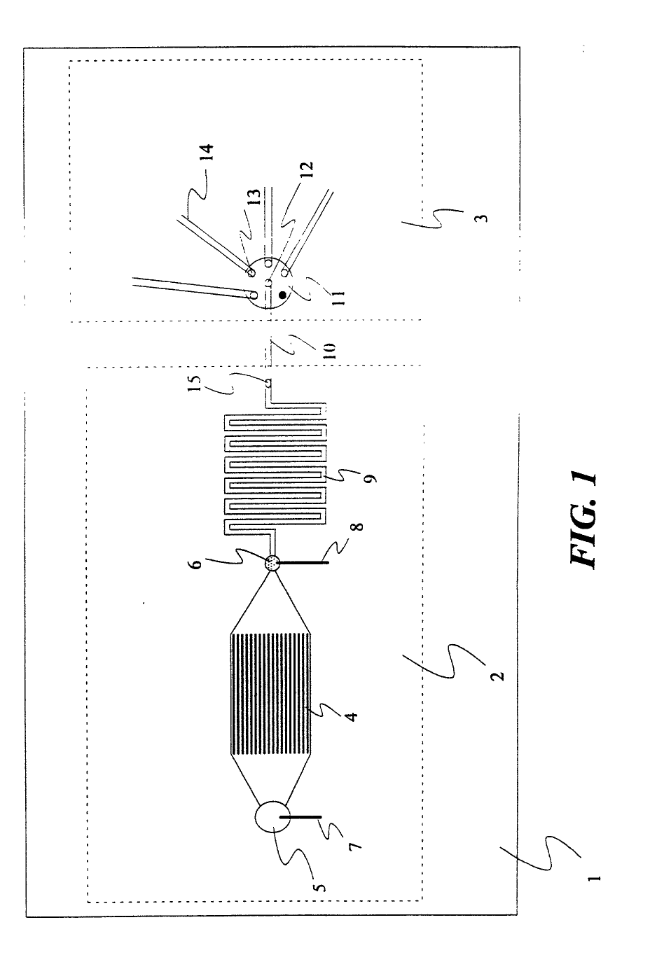

Referring now to FIG. 1, chip 1 comprises a microfabricated EOF pump 2, a selection valve 11 and microfluidic conduits 3 (partially shown). Multiple units of this design may be integrated onto a single chip as desired. In this illustrated embodiment, chip 1 is a glass substrate and fabrication of the microfluidic system components is performed using standard photolithographic techniques. Preferably, a sacrificial mask of Cr/Au is used, the Chromium layer (approximately 100 to 500 angstroms thick) being present solely to enhance the adhesion between the substrate and gold layer. HF is the preferred etchant and can be prepared in various solutions including HF/NH4F, HF/HNO3, HF/H3PO4, and concentrated HF. Pump 2 comprises multiple pump-channels 4, a high voltage electrode reservoir 5, a bubble-free electric connection joint 6, and an isolation channel 9. Bubble-free electric connection joint 6 functions as the ground electrode reservoir for the system most of the time, but may be used to apply an electric potential to the fluidic system as desired. The dimensions of pump channels are normally between 0.1 μm to 500 μm, preferably 1 μm to 200 μm, and more preferably, 5 μm to 50 μm. Multiple channels are often desirable on one chip, as the flow rate of the system is proportional to the number of pump channels. Systems may be thus tailored for a desired flow rate by adjusting the size and number of channels. In general it would be possible to fabricate approximately 1000 pump channels which are approximately 100 μm in width on a 10 centimeter wide substrate.

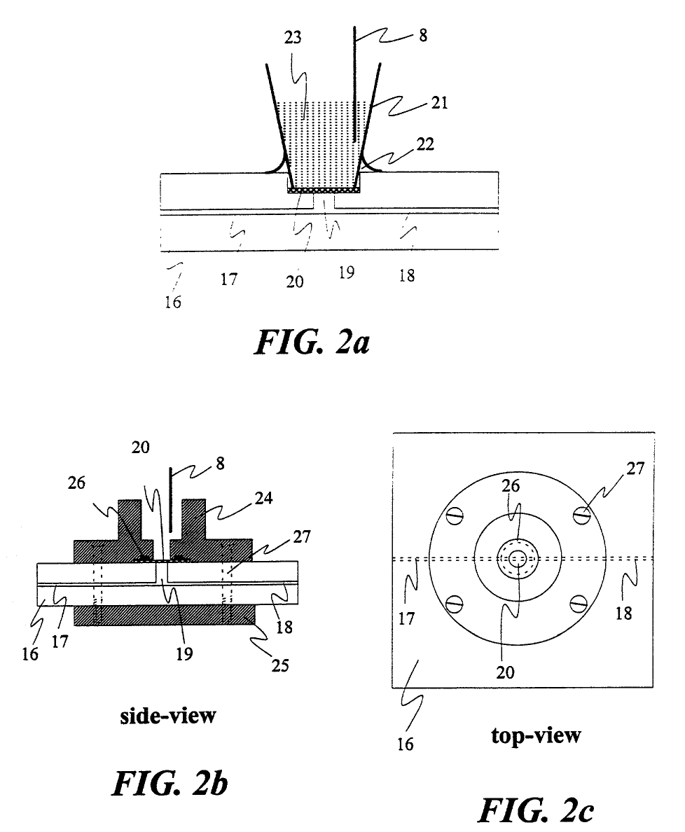

FIG. 2a shows the schematic assembly of bubble-free electric connection joint 6 (also the ground electrode reservoir). Ion exchangeable membrane 20 is fixed over access hole 19 and small bottomless container 21 is sealed on top of the membrane 20 and secured in position using adhesive 22 (preferably epoxy). Membrane 20 is preferably a flat Nafion membrane sheet, but may be any ion exchangeable membrane. Access hole 19 is preferably fabricated to be smaller than the space occupied by membrane 20 and branches off in a T joint fashion to channels 17 and 18. The access hole/membrane assembly should be carefully fabricated so that the membrane 20 seals access hole 19 so that no fluids are able to pass through. A buffer electrolyte solution 23 is introduced into container 21. The ion exchangeable membrane 20 in this assembly allows ions to pass through such that bubble-free electrode 8 and the solutions in the access hole 19 are electrically connected, but fluids cannot pass across the membrane 20. In FIGS. 2b and 2c, two blocks 24 and 25 on the opposite sides of the chip 16 are held together through four screws 27. The top block 24 will press an O-ring 26 on the membrane 20 against the shoulder of the access hole 19, to prevent fluids from leaking across the membrane 20. FIG. 2c shows a top-view of the bubble-free electric connection joint assembly.

Referring back to FIG. 1, when a voltage is applied across the pump-channels 4 through two bubble-free electrodes 7 and 8, EOF is created in the pump channels 4. Because the membrane 20 in the bubble-free electric connection joint 6 prevents fluids from moving across the membrane, the EOF can thus be used to drive the solution in isolation channel 9 and hence the fluids in the rest of microfluidic conduits 3. Isolation channel 9 is used to prevent fluids in the microfluidic conduits 3 from contaminating the pump channels 4 and pump solution 23 in the bubble-free electric connection joint 6 and high voltage reservoir 5. In another embodiment of this invention, the isolation channel is used to hold an air bubble 15 or an oil droplet as a marker for monitoring the pumping flow rate.

Selection valve 11 in FIG. 1 is used to direct the pump to various channels of conduit networks. The common port 12 of the selection valve 11 is normally directly connected to the pump part of the chip 2. Selection valve 11 allows connection of the common port 12 to any but one of the of the selection ports. For example, when the common port 12 is connected to selection port 13, the pump assembly 2 will be able to drive fluids in channel 14 and the down stream conduits.

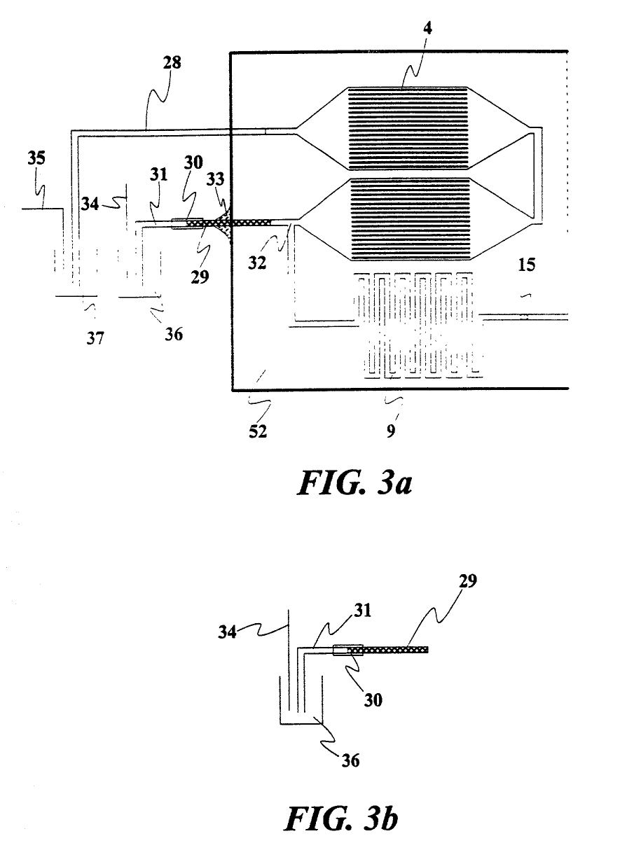

In another embodiment, the pump element 2 of FIG. 1 may be reconfigured as illustrated in FIG. 3a. Multiple groups of channels are connected in series or channels may be curved (not shown) to form pump channels 4 in order to create higher pump pressures than are possible from a single group of channels. Ideally, every single pump channel experiences equal electric field strength. The high voltage electrode reservoir 37 and ground electrode reservoir 36 are moved outside the chip body 52. A tube, preferably a capillary tube, 28 is used to connect one end of the pump channels 4 to the high voltage electrode reservoir 37. A bubble-free electrode (referring to FIG. 3b) is connected to the other end 32 of the pump channels 4 and sealed using adhesive 33 (preferably epoxy). This configuration allows reservoirs of large volumes to be used, which is important for stable pumping rate because electrolysis changes the pH of the pump solution, which in turn changes the pump flow rate. Regular metal electrodes 34 and 35 (preferably though not necessarily platinum or gold wires) may be used directly in the high voltage electrode reservoir 37 and ground electrode reservoir 36. The volume of the large containers can be several liters if need be.

In this embodiment, a bubble-free electrode is employed to prevent electrolysis and bubble formation in or close to the microfluidic channels. Referring to FIG. 3b, one particular element of a bubble-free electrode is a piece of tube 29 filled with high viscous media. Tube 29 may be loaded with a viscous polymer solution or packed with porous media. The viscous polymer solution may be agarose gel with a concentration of greater than 0.5% (w/w), polyacrylamide gel with a concentration of greater than 1% (w/w), or other polymer gel solutions. In more preferred embodiments, the viscous polymer solution is polyacrylamide gel with a weight concentration of 2-10%. Polyacrylamide may be either a linear or cross-linked polymer. In additional embodiments, the polymerization reaction is performed in-situ in tube 29. Tube 29 may also be packed with porous media such as micro beads of smaller than 10 μm in diameter, more preferably between 0.1 μm to 3 μm in diameter. In-situ prepared polymeric monoliths such as sol-gel monoliths and acrylate polymer monoliths may also be used to prepare tube 29. When tube 29 is packed with porous media, an electrolyte solution is flushed through and filled the pores in tube 29. The flow resistance in tube 29 is very high when filled with such high viscous media. Tune 29 should normally be less than 1 m, preferably less than 10 cm, more preferably less than 3 cm in order to reduce the voltage drop across it. The diameter of tube 29 should normally be within 2 μm to 2 mm, more preferably within 25 μm to 250 μm.

The bubble-free electrode of FIG. 3b comprises a large container 36, a platinum or gold electrode 34, and a tube 29 filled with high viscous media. When tube 29 is short, another tube 31 filled with an electrolyte solution may be used to connect tube 29 through a joint 30 to the solution in the large container 36. The joint 30 is preferably a piece of silicone tubing that tightly fit to tube 29 and 31. Referring to FIG. 3a, as a potential is applied between electrodes 35 and 34, EOF is generated in pump channels 4. Because EOF in tube 29 is zero if polymer gel is fixed in the tube, or very small if tube 29 is packed with micro-porous media, the EOF generated in the pump channels 4 will drive fluids in isolation channel 9 and subsequently the fluids in microfluidic channel connected to the isolation channel 9. Electrolysis occurs and bubble forms only in the large volume reservoir 36, not at the tip of tube 29. The assembly shown in FIG. 3b is referred to as a bubble-free electrode in the present invention. Bubble-free electrodes can be used inside a microfluidic channel, or in small volume buffer electrolyte reservoirs (such as in electrodes 7 and 8 in FIG. 1). Such electrodes are bubble-free, and even more precisely, electrolysis-free. Because no electrolysis occurs at the tip of tube 29, the solution pH is maintained during operation in the microfluidic channel, or small volume buffer reservoirs connected to the bubble-free electrode.

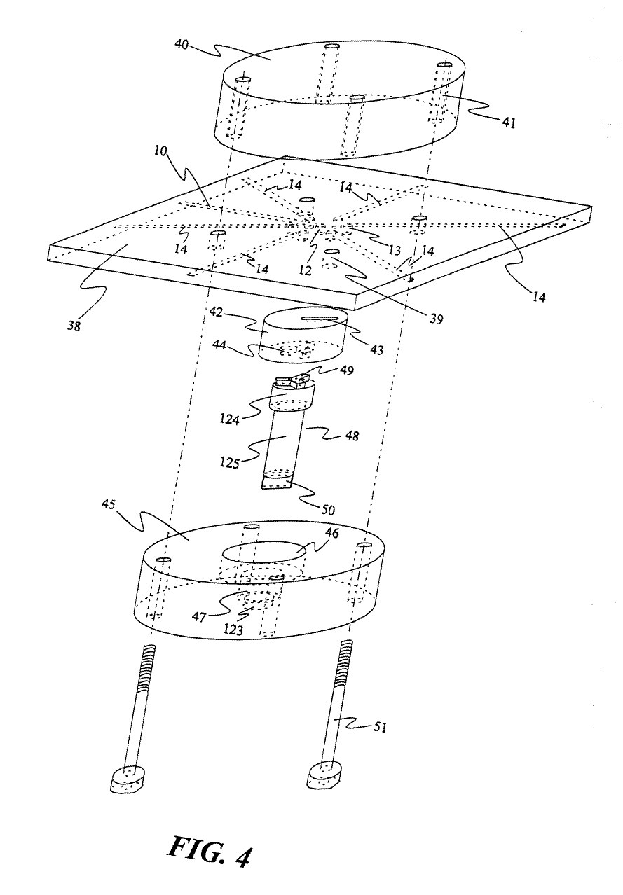

FIG. 4 shows an exploded view of a selection valve (such as selection valve 11 from FIG. 1) integrated onto a microchip 38. In this example, channels 14 connect microfluidic conduits to the selection ports and a connection channel 10 connects a pump to the common port of the selection valve. All these ports are normal access holes with their openings facing down. The diameters of these access holes should be less than 2 mm, preferably less than 1 mm, more preferably less than 500 μm, more preferably less than 200 μm, more preferably less than 100 μm, to reduce the connection dead volumes. A rotor 42 has a groove 43 on the top and a recessed structure 44 on the bottom. The groove 43 is used to make connections between the common port 12 to any one of the selection ports of the selection valve. Two blocks 40 and 45 are used to hold the rotor 42 tightly to the chip 38 through screws 51 and threads 41. Four through holes 39 on the chip 38 allow the screws 51 to go through. There is a three tiered recessed structure formed in the bottom block 45. The diameter of the first tier portion 46 of the recessed structure matches the diameter of the rotor 42 and its depth is slightly smaller than the height of the rotor 42. This permits the rotor 42 to be held tightly to the chip 38 when the two blocks 40 and 45 are tightened together by the screws 51. The diameter of the second tier portion 47 of the recessed structure matches the diameter of the larger portion 124 of a transmission rod 48. The diameter of the third tier portion 123 of the recessed structure matches the smaller portion 125 of the transmission rod 48. The raised structure 49 on this rod 48 matches the recessed structure 44 on the rotor. When all the pieces are placed tightly together, an external force is applied to the rod 48 through structure 50 to rotate the rotor 42 to a desired position so that the common port 12 is connected to a desired selection port of the selection valve. Rotation and positioning of the transmission rod 48 may be automatically operated through a step motor (not shown).

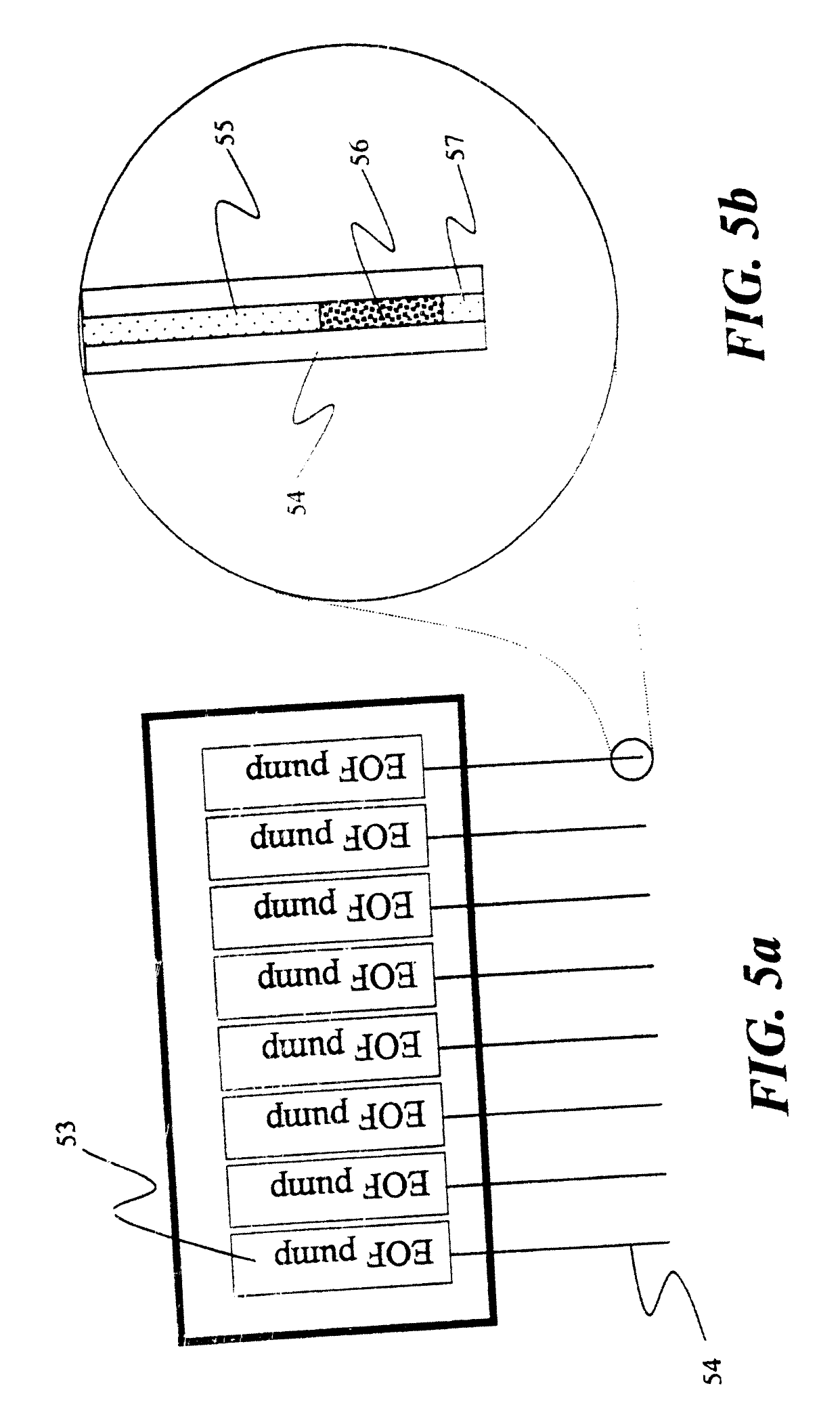

FIG. 5a shows a small volume pipettor constructed utilizing a microfabricated EOF pump 53. The pump portions may be conceptually similar to those detailed in FIG. 3a. The pipettor tip 54 is a piece of capillary tube such as glass capillary tube, stainless steel capillary tube or other polymeric tubing. The diameter of the pipettor tip may vary with the desired pipetting volume. It normally ranges from 5 μm to 1 mm, preferably between 25 to 250 μm. When the pump channels are narrow, for example less than 10 μm, a stable pumping rate of a few nanoliters per minute may be reliably created. Using a few seconds pipetting time, fluids of sub-nanoliter volumes may be reliably picked or delivered.

When handling fluids in these small volumes, it may be challenging to prevent solvent evaporation or cross contamination between samples. FIG. 5b shows one pipettor embodiment wherein a non-interfering fluid 55 is picked up in the pipettor tip, followed by target fluid 56, and then an additional segment of the non-interfering fluid 57. The target fluid 56 is sandwiched between two non-interfering fluid segments 55 and 57 so as to prevent evaporation of the target fluid 56. To deliver this small volume of fluid, the non-interfering fluid segments 55 and 57 are delivered with the target fluid 56. When fluid segment 55 is delivered it washes the residual of the target fluid 56, which facilitates complete and accurate delivery of the target fluid 56.

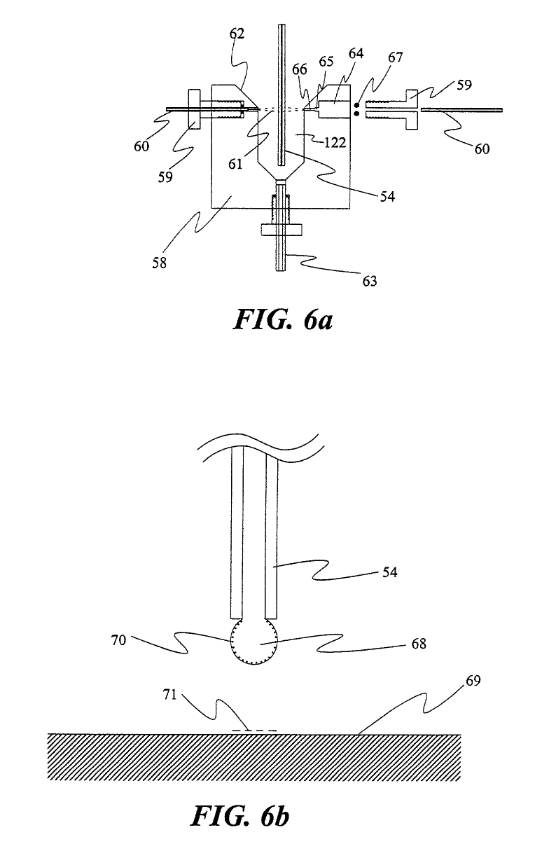

In another pipettor embodiment, referring to FIG. 6a, the outside and the end of pipetter tip is washed with a non-interfering fluid 61. The washing device 58 has a large guiding opening 62 that permits the pipettor tip 54 entering the washing chamber 122 easily. The non-interfering washing fluid is introduced using tubing 60 through a couple of small openings 66 on the opposite sides of the washing chamber 122. The openings 66 are preferably located on the top of the washing chamber. Tubing 60 is inserted all the way to the bottom of hole 65. An O-ring 67 is squeezed by a hollow screw 59 to seal the tubing 60 and secure it in position.

Generally, it will be desirable to have receiving fluid to accept the target fluid when very small volumes of fluids are transferred. This ensures that the target fluid is fully released and little hangs on the end of the pipettor tip. Sometimes, however, it is required to deliver small volumes of solutions to dry surfaces. In the embodiment shown in FIG. 6b, a potential may be applied through the bubble-free electric connection joint 6 (referring to the pump configuration of FIG. 1) or the bubble-free electrode 29 (referring to the pump configuration of FIG. 3a) to the target fluid 68 to make its surface 70 charged, which reduces the surface tension of the target fluid 68 and hence becomes more easily released to a dry surface 69. Appropriate potential may also be applied to the dry surface 69 to create charge 71 opposite to that on the droplet 68. The local electric field will direct the target fluid 68 to a desired position 71 on the dry surface 69. This method may also be used to release a target fluid to a liquid surface to avoid contact between the pipettor tip 54 and receiving solution.

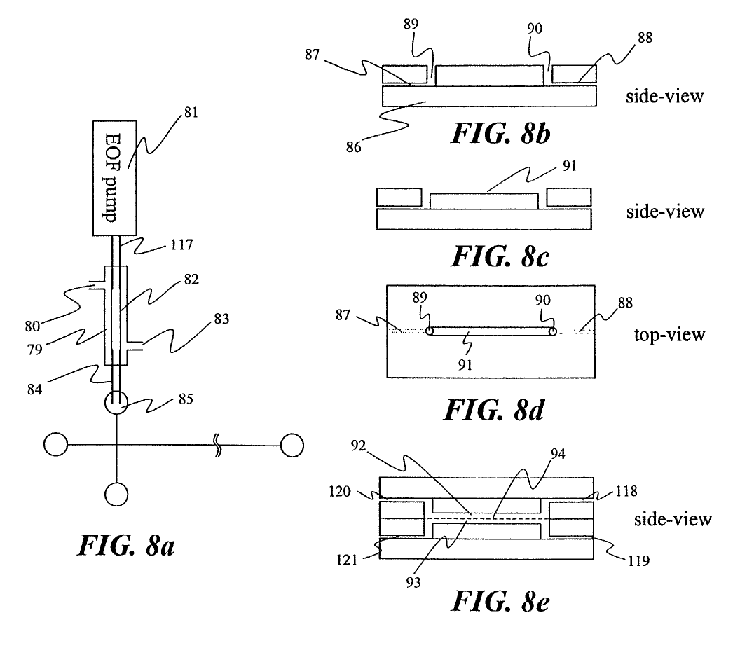

In another pipettor embodiment, referring to FIG. 8a, a micro-dialysis jacket is attached to a small volume pippetor tip to permit desalting, pH adjustment, concentration, and other such functions requiring dialysis-type mechanisms. A tubular membrane 82 such as porous cellulose, porous PTFE or Nafion (or any other ion exchangeable membrane) is used to connect a pipettor tip 84 to a connection tube 117. The other end of tube 117 is connected to a microfabricated EOF pump. A jacket 79 surrounding the tubular membrane is secured and sealed to the pipettor tip 84 and connection tube 117. As a proper external solution goes into the jacket through opening 83, passes across the outside of the tubular membrane 82 and exits through the other opening 80, the salt concentration of the solution inside the tubular membrane 82 may be reduce and the pH of the solution may be adjusted.

In an additional aspect of this embodiment, a porous cellulose membrane combined with an aqueous solution containing low or not salt as an external solution is used for desalting; a Nafion (or any other ion exchangeable) membrane combined with a certain pH buffer solution as an external solution is used for pH adjustment; and a porous PTFE membrane combined with dry air as an external fluid is used for concentration.

Normally, the external solution is constantly flowing across the outside of the tubular membrane 82. By using this particular pipettor configuration to pick up a sample solution, allowing the solution to pass across the tubular membrane, and then delivering the solution to a target location (for example a sample reservoir 85 on a microchip), the delivered sample may have already been desalted and/or its pH adjusted.

In another embodiment shown in FIG. 8e, the membrane 94 such as porous cellulose, porous PTFE or Nafion (or any other ion exchangeable membrane) is directly integrated into a chip system. To construct this system, traditional chip 86 as shown in FIG. 8b can first be fabricated. Channels 87 and 88 are connected to a pump and a microfluidic network. The diameter of the two access holes 89 and 90 are preferably less than 1 mm, more preferably less than 500 μm, and even more preferably less than 100 μm, in order to reduce the dead volume. A groove 91 is then created on the top of the chip between the two access holes 89 and 90. FIG. 8d shows a top-view of the chip after groove 91 has been fabricated. Then a sheet membrane (such as porous cellulose, porus PTFE, Nafion, or any other ion exchangeable membrane) 94 is employed to cover the groove and access holes (89 and 90). Another chip having a similar groove is then used to enclose the membrane and secure it in position as illustrated in FIG. 8e. Screws may be used to tighten these two chips together. The groove on the second chip forms channel 92 and the groove on the first chip forms channel 93. To illustrate, when water enters channel 118, passes through channel 92 and exits channel 120 and a sample solution, preferably prepared on chip, enters channel 121, passes through channel 93 and exits channel 119, the sample has already been desalted as it leaves channel 93. The two solutions above and below the membrane 94 may flow in the same direction, but material transferring across the membrane is more efficient when they flow counter-currently. Adjustment of sample pH and concentration of a sample may also be performed using this device.

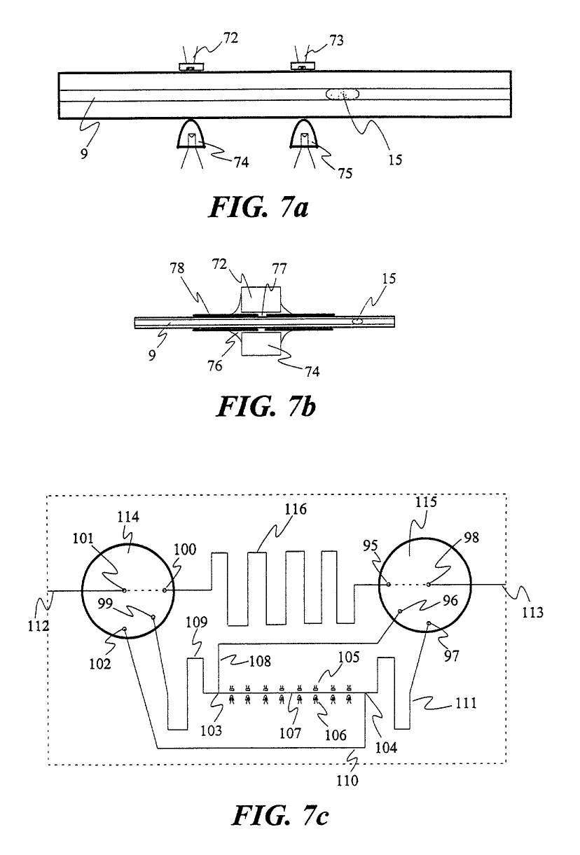

FIG. 7a shows an on chip system for flow rate monitoring. Air bubble 15 is introduced into isolation channel 9. LED/photodiode pairs 74/72 and 75/73 are mounted operatively on both sides of the isolation channel 9. FIG. 7b presents a schematic diagram of the LED/photodiode 74/72 assembly on the chip. LED's and photodiodes are glued in position using adhesive 76 (preferably epoxy resin). On both sides of the isolation channel 9, a Cr layer 78 is sputtered to block the environmental light and other scattered light. An opening 77 is fabricated for LED light to pass through the channel and reach the photodiode on the opposite side of the channel. Both the LED and photodiode are switched on at all times such that the photodiode is constantly detecting an optical signal from the LED. As the air bubble 15 passes through the assembly, a large signal change is detected by the photodiode presumably due to an optical focusing effect of the meniscus of the air bubble. If the bubble is large, two separate strong signals, one for each meniscus, may be detected. Generally only one, more often the rising signal, is selected to record the position of the air bubble. The moving velocity of the air bubble 15 is calculated based on the distance of two LED/photodiode pairs and the time for the air bubble 15 to move from one LED/photodiode pair 74/72 to the other 75/73. Any variation of the pump flow rate will be detected by monitoring the velocity change of the air bubble. Once a velocity change is detected, the pump voltage may be adjusted properly to resume the same pump rate.

In another rate monitoring embodiment, now referring to FIG. 7c, flow rate monitoring channels are separated from the main conduits. Two selection valves 114 and 115 are used in this assembly. Channel 112 connects the pump to the common port 101 of selection valve 114 and channel 113 connects the common port 98 of selection valve 115 to the rest of the microfluidic conduits. During normal operation, selection valve 114 connects common port 101 to selection port 100 and selection valve 115 connects common port 98 to the selection port 95. An air bubble is pre-introduced into channel 107 between two T-connectors 103 and 104. To measure the flow rate, selection valve 114 connects the common port 101 to selection port 99 and selection valve 115 connects the common port 98 to selection port 97 if the air bubble is close to T-connector 103. Alternatively, if the air bubble is close to T connector 104, selection valve 114 connects the common port 101 to selection port 102 and selection valve 115 connects the common port 98 to selection port 96. Multiple LED/photodiode pairs are used to measure the velocity of the air bubble. The total distance of channels 109, 107 and 111 should be the same as that of channels 110, 107 and 108, and equal to that of channel 116. When all channel dimensions are the same, this ensures the same flow resistance whether the system is in normal operation or in flow rate measurements.

### EXAMPLES

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Microfabrication of Glass Chips

Schematic diagrams showing preferred embodiments of the small volume fluid manipulation and transportation devices of the present invention are provided in FIGS. 1 through 8. A variety of methods known in the art may be used to make and use the claimed fixed-volume-injectors. For example, the chip microfabrication protocols disclosed in Analytical Chemistry 71 (1999) 566-573, or their equivalents known in the art are readily be adapted to produce the chip component of the hybrid apparatus of the present invention.

Alternative methods known in the art may be employed within the scope of the present invention. For example, for photolithograpy a thin sacrificial layer of Cr/Au (300 Å Cr and 0.5 μm Au) may be deposited onto a glass wafer, followed by photoresist coating (Shipley photoresist 1818). After soft baking at 80° C., the photoresist may be exposed to UV radiation through a mask. The mask pattern will be transferred to the wafer after the photoresist is developed. After the exposed Cr/Au is etched off using gold and chromium etchants, the channel pattern is chemically etched into the glass. We have been using concentrated HF as the chemical etchant with an etching rate of ca. 7 μm per minute at 21° C. for borofloat glass. After etching, the residual photoresist and Cr/Au may be stripped and access holes were drilled. The etched wafer may be thermally bonded with another wafer to enclose the grooves and form channels.

The bonded chips are then taken to a dicing saw and diced to form the three-piece and two-piece fixed-volume-injectors.

The operations of the various embodiments of the present invention are controlled by a controller (not shown) to accomplish the functions recited herein. It would be within a person skilled in the art to implement the program code given the functions and features disclosed herein.

All of the methods and apparatus disclosed and claimed herein can be made and executed without undue experimentation in light of the present disclosure. While the invention has been described with respect to the described embodiments in accordance therewith, it will be apparent to those skilled in the art that various modifications and improvements may be made without departing from the scope and spirit of the invention. For example, it will be apparent to those of skill in the art that variations may be applied to the methods and apparatus and in the steps or in the sequence of steps of the methods described herein without departing from the concept, spirit and scope of the invention. It also will be apparent that certain substance such as polymeric and ceramic materials may be substituted for the glass materials described herein to achieve the same, similar or improved results. By way of example and not limitation, the EOF pump concepts of the present invention is described in connection with micro-channels in a microfabricated chip. It is understood that the present invention is applicable to integrated microfluidic systems for chemical analysis and sensing, and analytical separation techniques such as capillary electrophoresis, capillary electrochromatography, microcolumn liquid chromatography, flow injection analysis, and field-flow fractionation. It is also applicable to microarray spotting and MALDI-MS sample deposition. Furthermore, while the separation channels in the described embodiments are defined by micro-separation channels etched in a substrate (micro-fluidics type devices or bio-chips), it is understood that the concepts of the present invention is equally applicable to columns or tubes defining the micro-channels.

All such similar substitutes and modifications apparent to those skilled in the art are deemed to be within the spirit, scope and concept of the invention as defined by the appended claims. Accordingly, it is to be understood that the invention is not to be limited by the specific illustrated embodiments, but only by the scope of the appended claims.

We claim:

1. A microfluidic system, comprising:
a substrate;
a fluid network disposed on the substrate for transporting fluids; and
an electrical connection means for application of an electric potential across a first segment of the fluid network such that electroosmotic flow is induced in that segment; a coupling means for isolating electrical fields from a second segment of the fluid network while providing fluid communication between the first and second segements of the fluid network.

2. A microfluidic system as in claim 1, wherein the fluid network comprises at least one fluid channel.

3. A microfluidic system as in claim 1, wherein the first segment of the fluid network comprises a plurality of fluid channels operatively connected on both ends to a single fluid channel.

4. A microfluidic system as in claim 1, wherein the electrical connection means includes a first electrode reservoir and a second electrode reservoir, each operatively connected to the first segment of the fluid network.

5. A microfluidic system as in claim 4, wherein the second electrode reservoir includes an electrolysis free electrode for the application of electrical signals to the system without inducing electrolysis in the second reservoir.

6. A microfluidic system as in claim 4, wherein the second electrode reservoir comprises a bubble-free electric connection joint.

7. A microfluidic system as in claim 1, further comprising a selection means for routing fluid from the fluid network to external fluid systems.

8. A microfluidic system as in claim 1, further comprising means for preventing contamination of fluids between the first and second segment.

9. An electrolysis free electrode, comprising:
a protective housing;
an ion transferring compound contained in a protective housing, the compound being such that electrons cannot be transferred through it nor can fluids be drawn into it.

10. An electrolysis free electrode as in claim 9, wherein the protective housing comprises a flexible tubing.

11. An electrolysis free electrode as in claim 9, wherein the ion transferring compound comprises one of the following compounds: agarose gel with a concentration of greater than 0.5% (w/w), polyacrylamide gel with a concentration of greater than 1% (w/w), or other polymer gel solutions, polyacrylamide gel with a weight concentration of 2-10%, sol-gel monoliths, acrylate polymer monoliths, electrolyte solution.

12. A bubble-free electric connection joint, comprising:
a substrate;
an access hole defining a first opening and a second opening disposed in the substrate;
an ion exchangeable membrane fixedly connected over the first opening of the access hole such that electrical signals is permitted to pass through the ion exchangeable membrane but fluids are retained by the membrane;
a fluid containing means fixedly connected above the ion exchangeable membrane opposite the first opening of the access hole for containing fluids;
at least one fluid channel defined in the substrate which intersects with the second opening of the access hole such that fluid contained in the fluid channel is in contact with the ion exchangeable membrane

13. A microfluidic system as in claim 12, wherein the fluid channel intersects with the second opening of the access hole in more than one location such that fluid flows past the access hole while maintaining contact with the ion exchangeable membrane.

14. A micropippetor device comprising:
a microfabricated EOF pump; and
means for discharging fluid.
